(19) United States
(12) Patent Application Publication
(10) Pub. No.: US 2019/0255758 A1
(43) Pub. Date: Aug. 22, 2019

(54) MOLDING APPARATUS AND METHOD

(71) Applicant: HIMAX TECHNOLOGIES LIMITED, Tainan City (TW)

(72) Inventor: Jui Tang Chang, Tainan City (TW)

(21) Appl. No.: 15/901,698

(22) Filed: Feb. 21, 2018

(51) Int. Cl. B29C 59/00; B29C 59/02

(52) U.S. Cl. CPC B29C 59/002; B29L 2011/00; B29C 59/02

(57) ABSTRACT

A molding apparatus includes a working stamp disposed above a wafer; a vacuum chuck operatively disposed below the wafer and configured to hold the wafer by vacuum force, the vacuum chuck including an inner chuck and an outer chuck surrounding the inner chuck capable of individually moving axially; and a separating ring operatively disposed above a periphery of the wafer.

### BACKGROUND OF THE INVENTION

### 1. Field of the Invention

The present invention generally relates to molding, and more particularly to apparatus and method of demolding a wafer.

### 2. Description of Related Art

Replication is one of molding processes for manufacturing optics by transferring the optical surface of a master (or mold) to the surface of a wafer (or working piece).

When the replication process finishes, the wafer is demolded to be separated from the master. The demolding stage is commonly executed by exerting pressure on the periphery of the wafer. For an 8-inch wafer with a thickness of 0.25 mm, the periphery of the wafer usually has a range of 0.8-3.6 mm. Due to disequilibrium on the surface of the wafer, the wafer is apt to warp and even break in the demolding stage.

Therefore, a need has arisen to propose a novel scheme to prevent wafer from breakage in the demolding stage.

### SUMMARY OF THE INVENTION

In view of the foregoing, it is an object of the embodiment of the present invention to provide molding apparatus with a vacuum chuck that is composed of an inner chuck and an outer chuck. The embodiment provides a two-stage method of demolding a wafer. The molding apparatus and method of the embodiment can efficiently demold a wafer without breaking the wafer.

According to one embodiment, a molding apparatus includes a working stamp, a vacuum chuck and a separating ring. The working stamp is disposed above a wafer. The vacuum chuck is operatively disposed below the wafer and configured to hold the wafer by vacuum force, the vacuum chuck including an inner chuck and an outer chuck surrounding the inner chuck capable of individually moving axially. The separating ring is operatively disposed above a periphery of the wafer.

According to another embodiment, a bottom surface of a wafer is clamped during molding by inner vacuum force and outer vacuum force respectively generated by an inner chuck and an outer chuck surrounding the inner chuck. The outer chuck releases a periphery of the wafer and is lowered when the wafer finishes molding. A downward pressing force is exerted on the periphery of the wafer to separate the periphery of the wafer from a working stamp. The inner chuck is being lowered and still holding the wafer with the inner vacuum force, while continuously exerting the pressing force on the periphery of the wafer. The inner chuck stops when reaching a predetermined position.

### BRIEF DESCRIPTION OF THE DRAWINGS

FIG. 1A shows a perspective view of molding apparatus according to one embodiment of the present invention;

FIG. 1B shows a cross-sectional view of the molding apparatus of FIG. 1A;

FIG. 2A schematically shows a top view illustrating the separating ring disposed above the wafer;

FIG. 2B and FIG. 2C schematically show side views illustrating the tooth and the inflating tube;

FIG. 3A to FIG. 3C show cross-sectional views of the molding apparatus of FIG. 1A illustrating a method of demolding a wafer according to one embodiment of the present invention;

FIG. 4 shows a flow diagram illustrating a two-stage method of demolding a wafer according to one embodiment of the present invention;

FIG. 5A shows a schematic diagram illustrating forces applied on the wafer in step 41 of FIG. 4 in companion with FIG. 3A; and

FIG. 5B shows a schematic diagram illustrating forces applied on the wafer in step 42 of FIG. 4 in companion with FIG. 3B.

### DETAILED DESCRIPTION OF THE INVENTION

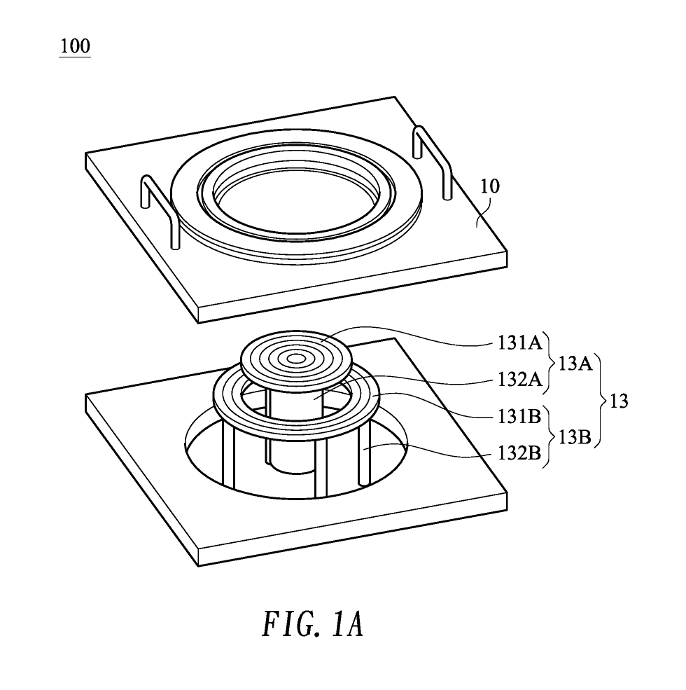

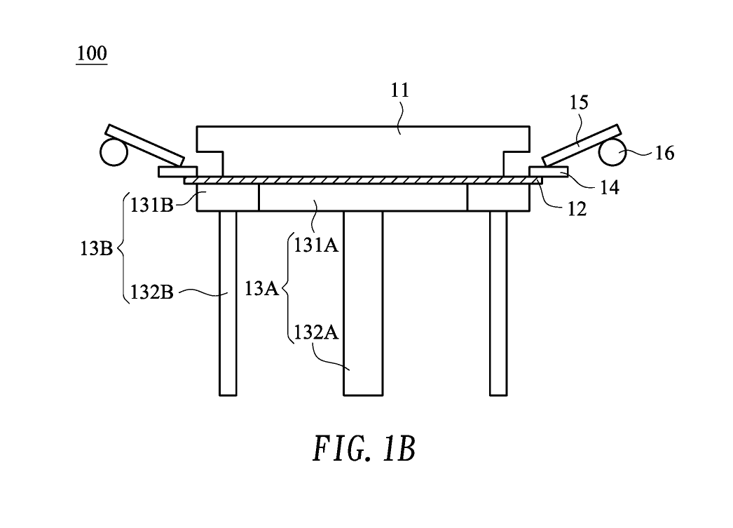

FIG. 1A shows a perspective view of molding apparatus 100 according to one embodiment of the present invention, and FIG. 1B shows a cross-sectional view of the molding apparatus 100 of FIG. 1A. In the embodiment, the molding apparatus 100 may, but not necessarily, be a replication machine adopted to perform a replication process that manufactures, for example, optics by transferring an optical surface of a working stamp (or a master or mold) 11 (disposed in a holder 10 and above a wafer 12) to a surface of the wafer 12.

The molding apparatus 100 of the embodiment may include a vacuum chuck 13 operatively disposed below the wafer 12 and configured to hold (or clamp or grip) the wafer 12 by vacuum force. According to one aspect of the embodiment, the vacuum chuck 13 may include at least two composing parts: an inner chuck 13A and an outer chuck 13B surrounding the inner chuck 13A. The inner chuck 13A and the outer chuck 13B may individually move axially (e.g., upwards or downwards). Specifically, in the embodiment, the inner chuck 13A may include a (circular) plate 131A with a flat surface against which the wafer 12 may be firmly held, and an inner column 132A supporting the plate 131A. The outer chuck 13B may include a ring 131B with a flat surface against which the wafer 12 may be firmly held, and a plurality of outer columns 132B supporting the ring 131B.

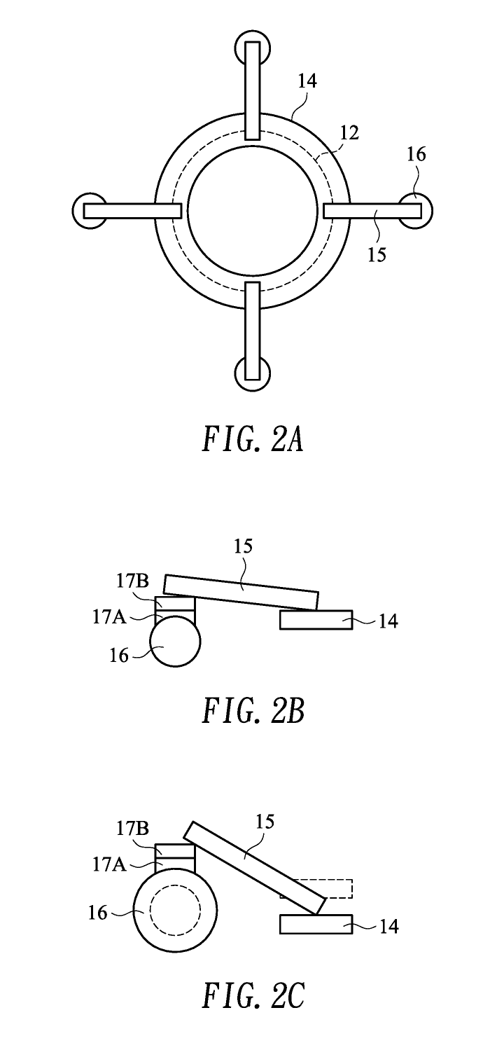

The molding apparatus 100 of the embodiment may include a separating ring 14 operatively disposed above a periphery of the wafer 12. FIG. 2A schematically shows a top view illustrating the separating ring 14 disposed above the wafer 12. When the wafer 12 finishes molding and is to be separated from the working stamp 11 (i.e., to be demoded), the separating ring 14 moves downwards to exert a (downward) pressing force to demold the wafer 12. Specifically speaking, the separating ring 14 moves downwards due to pressure of a plurality of teeth 15 (disposed above the separating ring 14), which are activated by corresponding inflating tubes 16 respectively disposed below first ends of the teeth 15 (as shown in FIG. 1B and FIG. 2A). Although four teeth 15 are exemplified in FIG. 2A, it is appreciated that the number of the teeth 15 may be greater than four.

FIG. 2B and FIG. 2C schematically show side views illustrating the tooth 15 and the inflating tube 16. Specifically, as shown in FIG. 2B, a first intermediate element 17A and a second intermediate element 17B are disposed, from bottom to top, between the inflating tube 16 and the tooth 15. The first intermediate element 17A may, for example, be made of plastic, and the second intermediate element 17B may, for example, be made of iron. In a deflation mode as shown in FIG. 2B, the inflating tube 16 is deflated and the tooth 15 is not activated. That is, the inflating tube 16 exerts no force on the first end (e.g., left end) of the tooth 15 via the first and second intermediate elements 17A and 17B. In an inflation mode as shown in FIG. 2C, the inflating tube 16 is inflated and the tooth 15 is activated. That is, the inflating tube 16 exerts force on the first end of the tooth 15 via the first and second intermediate elements 17A and 17B. The tooth 15 acts as a lever with a pivot located between the first end and a second end (e.g., right end) opposite the first end. Accordingly, the second end of the tooth 15 moves downwards and exerts force on the separating ring 14. It is appreciated that the separating ring 14 may move downwards by using mechanisms other than the teeth 15 and the inflating tubes 16.

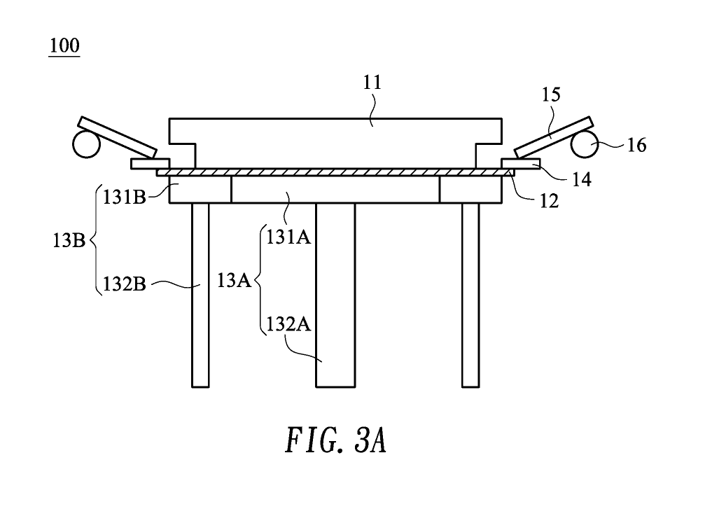

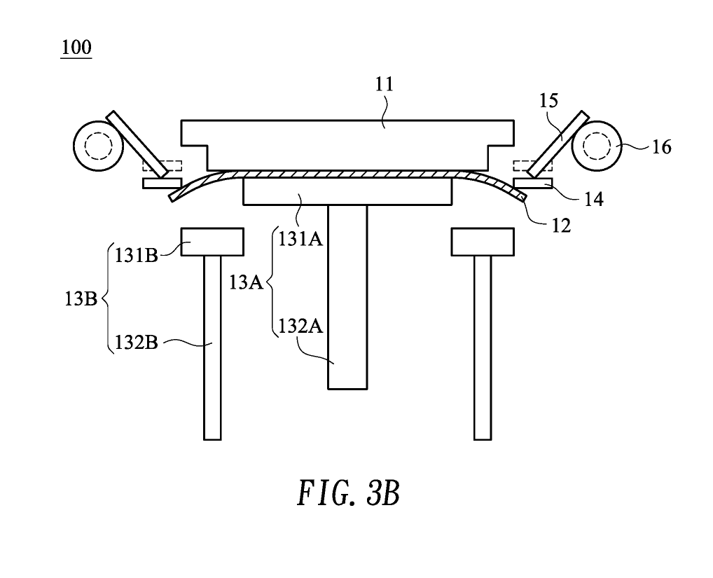

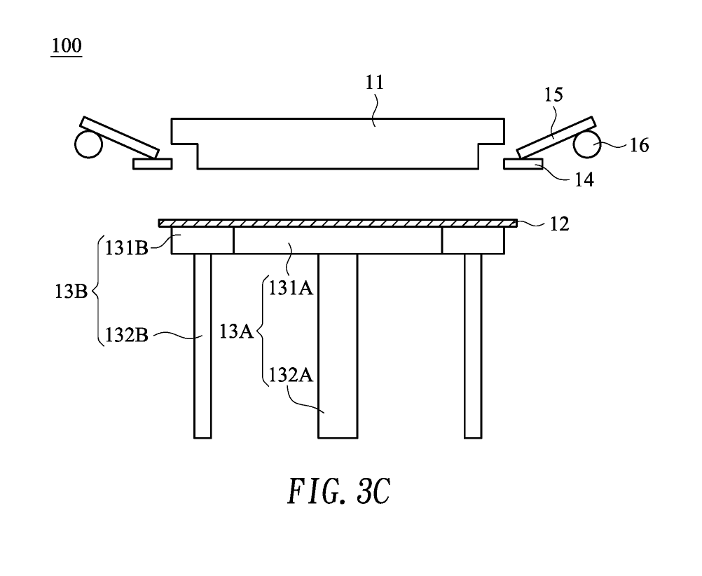

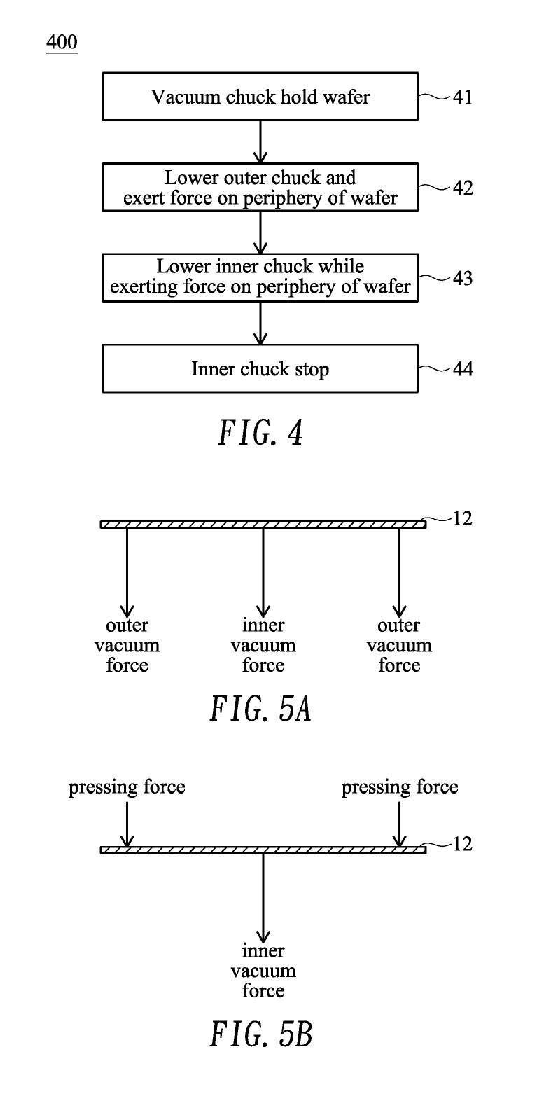

FIG. 3A to FIG. 3C show cross-sectional views of the molding apparatus 100 of FIG. 1A illustrating a method of demolding a wafer 12 according to one embodiment of the present invention. FIG. 4 shows a flow diagram illustrating a two-stage method 400 of demolding a wafer 12 in companion with FIG. 3A to FIG. 3C according to one embodiment of the present invention.

Referring to FIG. 3A, in step 41, the vacuum chuck 13 including the inner chuck 13A and the outer chuck 13B operatively holds the wafer 12 during molding (e.g., replication) by clamping a bottom surface of the wafer 12 by inner vacuum force and outer vacuum force, respectively. FIG. 5A shows a schematic diagram illustrating forces applied on the wafer 12 in step 41 of FIG. 4 in companion with FIG. 3A.

Referring to FIG. 3B, in step 42 (i.e., stage one), when the wafer 12 finishes molding, the outer chuck 13B releases a periphery of the wafer 12 from the outer vacuum force and is lowered. At the same time (or afterwards), the separating ring 14 exerts a (downward) pressing force on a periphery of the wafer 12, thus separating the periphery of the wafer 12 from the working stamp 11. FIG. 5B shows a schematic diagram illustrating forces applied on the wafer 12 in step 42 of FIG. 4 in companion with FIG. 3B.

Referring to FIG. 3C, in step 43 (i.e., stage two), the inner chuck 13A is lowered but still holding the wafer 12 with the inner vacuum force, while at the same time the separating ring 14 continuously exerts the (downward) pressing force on the periphery of the wafer. In the embodiment, the inner chuck 13A is lowered at a speed (e.g., 0.5mm/second) slower than a speed (e.g., 1 mm/second) at which the separating ring 14 moves downwards. In step 43, forces applied on the wafer 12 are substantially the same as in step 42 shown in FIG. 5B. As the separating ring 14 continuously exerts the (downward) pressing force on a periphery top surface of the wafer 12 while the inner chuck 13A holds the wafer 12 with the inner vacuum force in step 43, wafer breakage due to warping can be substantially kept from happening. Finally, in step 44, the inner chuck 13A and the separating ring 14 stop when the inner chuck 13A has reached a predetermined position.

Although specific embodiments have been illustrated and described, it will be appreciated by those skilled in the art that various modifications may be made without departing from the scope of the present invention, which is intended to be limited solely by the appended claims.

What is claimed is:

1. A molding apparatus, comprising:
a working stamp disposed above a wafer;
a vacuum chuck operatively disposed below the wafer and configured to hold the wafer by vacuum force, the vacuum chuck including an inner chuck and an outer chuck surrounding the inner chuck capable of individually moving axially; and
a separating ring operatively disposed above a periphery of the wafer.

2. The molding apparatus of claim 1, wherein the inner chuck comprises:
a plate with a flat surface capable of holding the wafer; and
an inner column supporting the plate.

3. The molding apparatus of claim 1, wherein the outer chuck comprises:
a ring with a flat surface capable of holding the wafer; and
a plurality of outer columns supporting the ring.

4. The molding apparatus of claim 1, wherein the separating ring moves downwards to exert a pressing force to demold the wafer when the wafer finishes molding.

5. The molding apparatus of claim 1, further comprising:
a plurality of teeth disposed above the separating ring and configured to press the separating ring to move downwards.

6. The molding apparatus of claim 5, further comprising:
a plurality of inflating tubes respectively disposed below first ends of the teeth.

7. The molding apparatus of claim 6, further comprising:
a first intermediate element and a second intermediate element disposed, from bottom to top, between the inflating tube and the tooth;
wherein in an inflation mode, the inflating tube is inflated to exert force on the first end of the tooth via the first and second intermediate elements, thereby a second end of the tooth moving downwards and exerting force on the separating ring.

8. A molding method, comprising:
clamping a bottom surface of a wafer during molding by inner vacuum force and outer vacuum force respectively generated by an inner chuck and an outer chuck surrounding the inner chuck;
the outer chuck releasing a periphery of the wafer and being lowered when the wafer finishes molding;
exerting a downward pressing force on the periphery of the wafer to separate the periphery of the wafer from a working stamp;
lowering the inner chuck and still holding the wafer with the inner vacuum force, while continuously exerting the pressing force on the periphery of the wafer; and
stopping the inner chuck when reaching a predetermined position.

9. The molding method of claim 8, wherein the inner chuck is lowered at a speed slower than a speed at which the periphery of the wafer is continuously pressed.

10. The molding method of claim 8, wherein the pressing force exerted on the periphery of the wafer is performed by a separating ring operatively disposed above the periphery of the wafer.

11. The molding method of claim 10, further comprising:
pressing the separating ring to move downwards by a plurality of teeth disposed above the separating ring.

12. The molding method of claim 11, further comprising:
exerting force on a first end of the tooth, thereby a second end of the tooth moving downwards and exerting force on the separating ring.

13. The molding method of claim 12, wherein the force exerted on the first end of the tooth is generated by an inflating tube disposed below the first end of the tooth.
